(19) United States
(12) Patent Application Publication
(10) Pub. No.: US 2015/0210069 A1
(43) Pub. Date: Jul. 30, 2015

(54) ADJUSTABLE PRINTHEAD

(71) Applicant: Hewlett-Packard Industrial Printing Ltd., Netanya (IL)

(72) Inventors: Alex VEIS, Kadima (IL); Eitan Pinhasi, Netanya (IL); Chen Turkenitz, Ramat Hasharon (IL); Adam Goren, Netanya (IL)

(21) Appl. No.: 14/610,539

(22) Filed: Jan. 30, 2015

(30) Foreign Application Priority Data
Jan. 30, 2014 (EP) 14275018.1

(51) Int. Cl. B41J 2/045

(52) U.S. Cl. CPC B41J 2/04505

(57) ABSTRACT

A printhead assembly includes a printbar beam member, a printhead, and a first eccentric pin. The printbar beam member includes a beam surface and a first cavity disposed through the beam surface. The printhead includes a printhead surface and a second cavity disposed through the printhead surface. The first eccentric pin may be inserted into the first cavity and the second cavity to couple the printhead to the printbar beam member. The first eccentric pin may rotate to adjust a position of the printhead relative to the printbar beam member along a first axis along the beam surface.

### BACKGROUND

A printhead assembly may include a printbar beam member and a plurality of printheads. The printheads may be spaced apart from each other along the printbar beam member. The printbar beam member may extend across a print zone including a width of media. The printheads may apply fluid onto the media to form images thereon.

### BRIEF DESCRIPTION OF THE DRAWINGS

Non-limiting examples are described in the following description, read with reference to the figures attached hereto and do not limit the scope of the claims. Dimensions of components and features illustrated in the figures are chosen primarily for convenience and clarity of presentation and are not necessarily to scale. Referring to the attached figures:

FIG. 1 is a block diagram illustrating a printhead assembly according to an example.

FIG. 2A is a top view illustrating a printhead assembly according to an example.

FIG. 2B is a schematic side view illustrating the printhead assembly of FIG. 2A according to an example.

FIG. 3 is a top view illustrating a printbar beam member of the printhead assembly of FIG. 2A according to an example.

FIGS. 4A and 4B are side views of a first eccentric pin and a second eccentric pin, respectively, of the printhead assembly of FIG. 2A according to examples.

FIG. 5 is a block diagram illustrating a printhead assembly according to an example.

FIG. 6 is a top view illustrating a printhead assembly of FIG. 5 according to an example.

FIGS. 7 and 8 are flowcharts illustrating methods of calibrating a printhead assembly according to examples.

### DETAILED DESCRIPTION

Printers such as inkjet page wide printers may include printhead assemblies that include a printbar beam member and a plurality of printheads disposed thereon. The printbar beam member extends across a print zone including a width of media. The printheads apply fluid such as ink onto media to form images thereon. The printheads are spaced apart from each other along the printbar beam member. Accurate spacing between printheads assists in reducing print quality defects such as visible strikes and line artifacts. As the span of the printhead assembly increases, for example, to accommodate wider media, the number of printheads on the printbar beam member may also increase. For example, the spacing between end nozzles of adjacent printheads should be within an acceptable range to prevent visible strikes and line artifacts. Thus, errors in the respective spacing between some of the printheads may increase resulting in an increase in print quality defects. Further, the number of defective printheads manufactured outside of acceptable manufacturing tolerances may increase.

In examples, a printhead assembly includes a printbar beam member, a printhead, and a first eccentric pin. The printbar beam member includes a beam surface and a first cavity disposed through the beam surface. The printhead includes a printhead surface and a second cavity disposed through the printhead surface. The first eccentric pin may be inserted into the first cavity and the second cavity to couple the printhead to the printbar beam member. The first eccentric pin may rotate to adjust a position of the printhead relative to the printbar beam member along a first axis along the beam surface. The adjustment of printheads with respect to the printbar beam member may enable accurate spacing between printheads on the printbar beam member. The adjustment of printheads with respect to the printbar beam member may also decrease the number of defective printheads to be used for the printhead assembly. Thus, adjustable printhead and/or printhead assemblies may decrease print quality defects and the cost of the printheads.

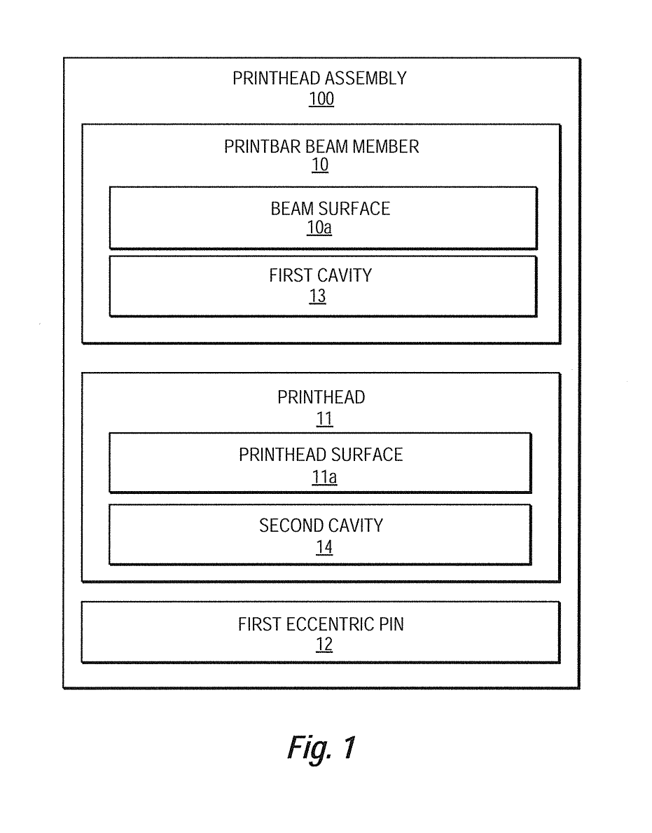

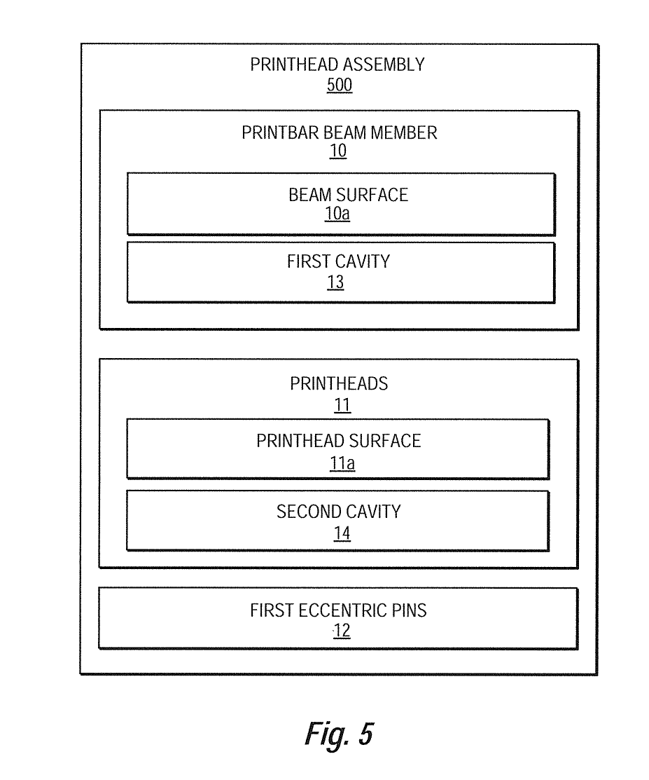

FIG. 1 is a block diagram illustrating a printhead assembly according to an example. Referring to FIG. 1, in some examples, a printhead assembly 100 includes a printbar beam member 10, a printhead 11, and a first eccentric pin 12. An eccentric pin, for example, may have its axis of revolution displaced from its center so that it is capable of imparting reciprocating motion. That is movement of an offset portion (FIG. 4A) of the respective eccentric pin 11 from one position to another position within a respective cavity may provide linear movement to the respective printhead 11. The printbar beam member 10 includes a beam surface 10a and a first cavity 13 disposed through the beam surface 10a. The printhead 11 includes a printhead surface 11a and a second cavity 14 disposed through the printhead surface 11a. The printhead surface 11a, for example, may be configured to oppose and/or contact the printbar beam member surface 10a. The first eccentric pin 12 may be inserted into the first cavity 13 and the second cavity 14 to couple the printhead 11 to the printbar beam member 10.

Referring to FIG. 1, in some examples, the first eccentric pin 12 may rotate to adjust a position of the printhead 11 relative to the printbar beam member 10 along a first axis along the beam surface 10a. For example, the first axis may be transverse to a printing direction. In some examples, the printhead 11 may remain on the printbar beam member 10 during rotation of the first eccentric pin 12. Alternatively, the printhead 11 may be removed from the printbar beam member 10 prior to the rotation of the first eccentric pin 12 and placed back on the printbar beam member 10 after completion of the rotation of the first eccentric pin 12. That is, after completion of the rotation of the first eccentric pin 12, the first eccentric pin 12 disposed through the second cavity 14 of the printhead 11 may be reinserted back into the corresponding first cavity 13 of the printbar beam member 10 to place the printhead 11 in a new position (e.g., an alignment state) on the printbar beam member 10. In some examples, the first cavity 13 may include a first hollow sleeve and the second cavity 14 may include a second hollow sleeve.

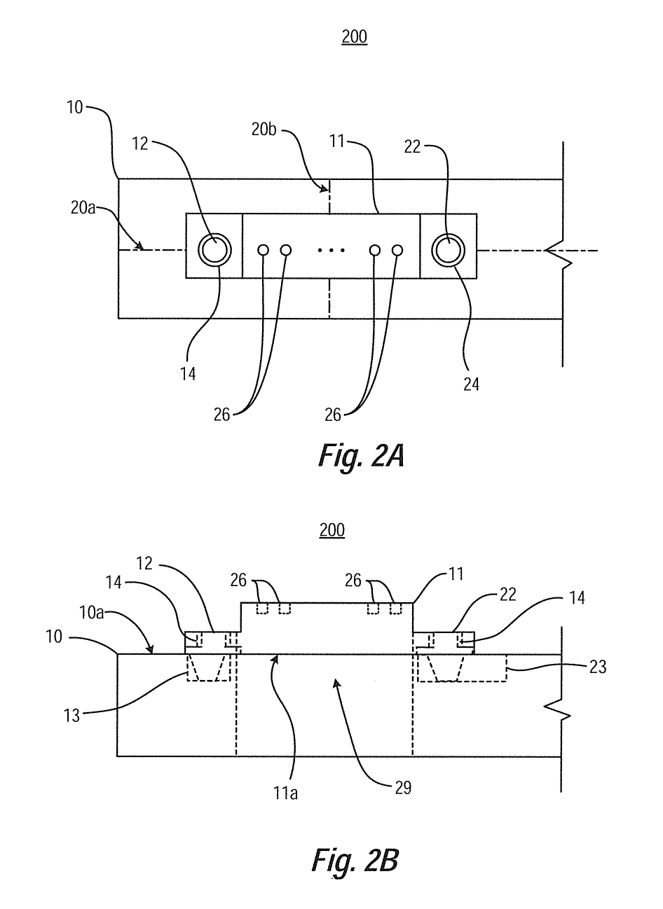

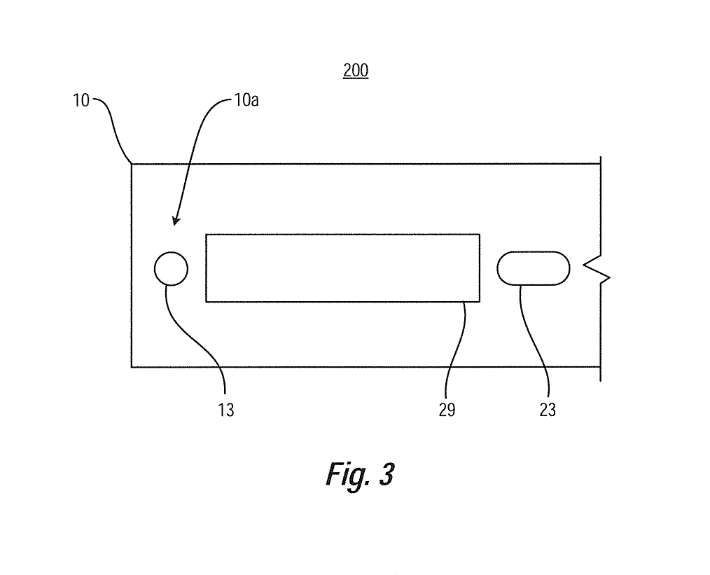

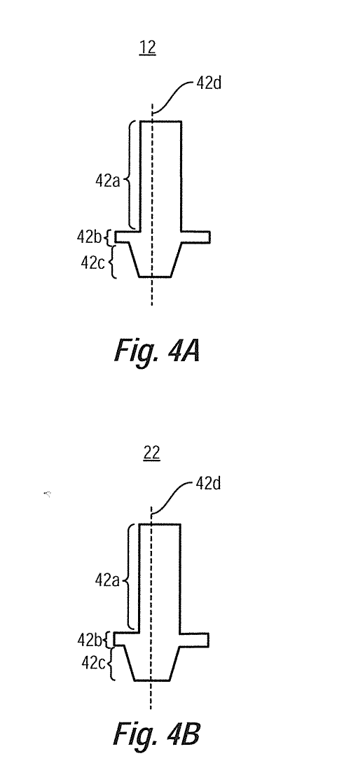

FIG. 2A is a top view illustrating a printhead assembly according to an example. FIG. 2B is a schematic side view illustrating the printhead assembly of FIG. 2A according to an example. FIG. 3 is a top view illustrating a printbar beam member of the printhead assembly of FIG. 2A according to an example. In some examples, the printhead assembly 200 may include the printbar beam member 10, the printhead 11, and the first eccentric pin 12 previously described with respect to the printhead assembly 100 of FIG. 1. The first eccentric pin 12 may be rotated to adjust the printhead 11 along the first axis 20a of the printbar beam member 10. In doing so, at times, the printhead 11 may also unintentionally be adjusted along the second axis as well (e.g., the printing direction). Referring to FIGS. 2A-3, in some examples, the printhead assembly 200 may also include a second eccentric pin 22. The second eccentric pin 22, for example, may be provided to adjust the printhead 11 along the second axis 20b of the printbar beam member 10 (e.g., a printing direction). Additionally, the printbar beam member 10 may also include a third cavity 23 disposed through the beam surface 10a, a printhead receiving area 29, and printbar fluid ports (not illustrated).

In some examples, the printbar beam member 10 may include an extrusion beam. Also, the printhead 11 may include a fourth cavity 24 disposed through the printhead surface 11a, nozzles 26, and printhead fluid ports (not illustrated). For example, the printhead fluid ports and the printbar fluid ports may be placed in fluid communication with each other when the printhead 11 is installed on the printbar beam member 10 to pass fluid therebetween. Fluid in the printhead 11 may be selectively passed through the respective nozzles 26 of the printhead 11, for example, to form an image on media. In some examples, the fluid is ink.

Referring to FIGS. 2A-3, in some examples, the first eccentric pin 12 may be inserted into the first cavity 13 and the second cavity 14 to couple the printhead 11 to the printbar beam member 10. The first eccentric pin 12 may rotate to adjust a position of the printhead 11 relative to the printbar beam member 10, for example, along a first axis 20a along the beam surface 10a. In some examples, the first eccentric pin 12 may have eccentricity in a range from −30 microns to 30 microns. That is, the linear range of movement of the printhead 11 imparted by a full rotation of the first eccentric pin 12 may be about sixty microns. Additionally, in some examples, the second eccentric pin 22 may be inserted into the third cavity 23 and the fourth cavity 24 to couple the printhead 11 to the printbar beam member 10a.

In some examples, the first cavity 13 may be a first hollow sleeve, the second cavity 14 may be a second hollow sleeve, the third cavity 23 may be a third hollow sleeve, and a fourth cavity 24 may be a fourth hollow sleeve. For example, hollow sleeves may be used to accurately set the distance between a first nozzle of the respective printhead and a center of the hollow sleeve to enable the respective eccentric pins therein to freely rotate. In some examples, the first, second and fourth hollow sleeves may have a circular-shaped opening and the third hollow sleeve may have an oval-shaped opening. For example, the third cavity 23 and/or third hollow sleeve of the printbar beam member 10 may be shaped as an oval such as a slit. The slit may be arranged to direct movement of the printhead 11 in a cross-print direction (along the first axis 20a). The slit may also enable the second eccentric pin 22 to adjust the printhead 11 along the second axis 20a without unintentionally adjusting it along the first axis 20b.

Referring to FIGS. 2A-3, in some examples, the second eccentric pin 22 may rotate to adjust the position of the printhead 11 relative to the printbar beam member 10, for example, along a second axis 20b along the beam surface 10a. The second axis 20b may be different than the first axis 20b. In some examples, the second axis 20b may be in a printing direction and the first axis 20a may be traverse to the printing direction (e.g., cross-print direction). The printhead receiving area 29 may include an oversized compartment to receive the printhead 11 and include space, for example, for it to move in respective directions corresponding to movement of the respective eccentric pins 12 and 22, as desired.

In some examples, the printhead 11 may remain on the printbar beam member 10 during rotation of the first eccentric pin 12 and second eccentric pin 22. Alternatively, the printhead 11 may be removed from the printbar beam member 10 prior to the rotation of the first eccentric pin 12 and the second eccentric pin 22, and placed back on the printbar beam member 10 after completion of the rotation of the respective eccentric pins 12 and 22. For example, after completion of the rotation of the first eccentric pin 12, the first eccentric pin 12 disposed through the second cavity 14 of the printhead 11 may be reinserted back into the corresponding first cavity 13 of the printbar beam member 10 to place the printhead 11 in a new position (e.g., alignment state) on the printbar beam member 10.

FIGS. 4A and 4B are side views illustrating a first eccentric pin and a second eccentric pin, respectively, of the printhead assembly of FIG. 2A according to examples. Referring to FIGS. 4A and 4B, in some examples, the first eccentric pin 11 and the second eccentric pin 22 may include a shaft portion 42a, an intermediate portion 42b, an offset portion 42c, and an axis of rotation 42d. The shaft portion 42a may be an elongated portion to be placed into the respective cavity such as a respective hollow sleeve of the printhead 11. The intermediate portion 42b may be disposed between the shaft portion 42a and the offset portion 42c. The offset portion 42 may be connected to the shaft portion 42a in an offset manner in which an axis of revolution 42d of the eccentric pin is displaced from its center so that it is capable of imparting reciprocating motion, for example, to the respective printhead 11.

In some examples, the respective eccentric pin 12 and 22 may be rotated such that the shaft portion 42a is rotated, for example, from being biased toward one side of a respective cavity, for example, to being biased toward the other side of the respective cavity by an amount to enable the printhead 11 to move a displacement distance to place the printhead 11 in an aligned state. In some examples, the respective eccentric pins 12 and 22 may be rotated by hand, a tool, and the like. For example, the misaligned state of a printhead 11 may be determined by a calibration image. Additionally, in some examples, a displacement distance to place the printhead 11 in an aligned state may be determined by open loop calibration methods, closed loop calibration methods, and the like. For example, a closed loop calibration method may include physically measuring the displacement distance (e.g., amount of misalignment) by a jig, and the like).

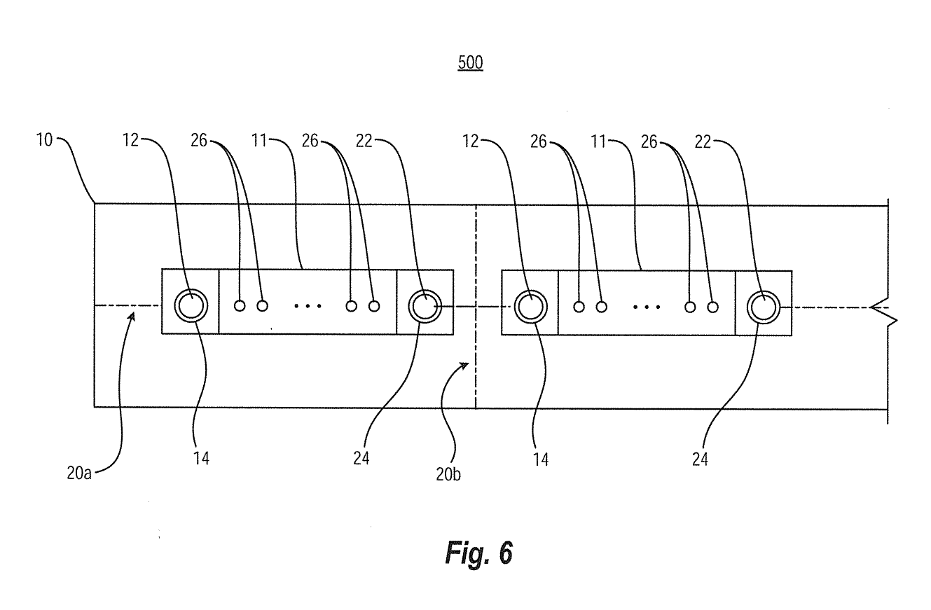

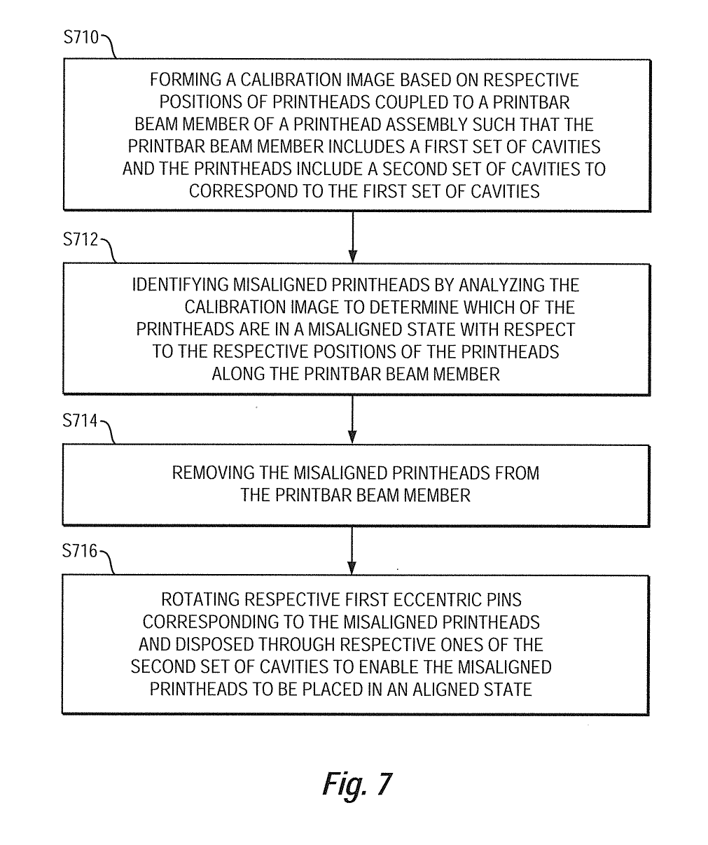

FIG. 5 is a block diagram illustrating a printhead assembly according to an example. FIG. 6 is a top view illustrating a printhead assembly according to an example. In some examples, a printhead assembly 500 may correspond to the printhead assemblies 100 and 200 as previously discussed with respective to FIGS. 1-4B and also include a plurality of printheads 11. Referring to FIGS. 5 and 6, in some examples, the printhead assembly 500 includes a printbar beam member 10, a plurality of printheads 11, and a plurality of first eccentric pins 12. The printbar beam member 10 may include a beam surface 10a and a plurality of first cavities 13 disposed through the beam surface 10a. Each one of the plurality of printheads 11 includes a printhead surface 11a and a second cavity 14 disposed through the respective printhead surface 11a. Each one of the plurality of first eccentric pins 12 may be inserted into the respective first cavity 13 and the corresponding second cavity 14 to couple the respective printhead 11 to the printbar beam member 10. Each one of the first eccentric pins 12 may be configured to rotate to adjust the respective position of the respect printhead 11 relative to the printbar beam member 10, for example, along a first axis 20a along the beam surface 10a.

Referring to FIGS. 5 and 6, in some examples, the printbar beam member 10 may also include a plurality of third cavities 23 disposed through the beam surface 10a. Each one of the printheads 11 may also include a fourth cavity 24 disposed through the respective printhead surface 11a. The printhead assembly 500 may also include a plurality of second eccentric pins 22. Each one of the second eccentric pins 22 may be inserted into the respective third cavity 23 and the corresponding fourth cavity 24 to couple the respective printhead 11 to the printbar beam member 10. In some examples, the first cavity 13 may be a first hollow sleeve, the second cavity 14 may be a second hollow sleeve, the third cavity 23 may be a third hollow sleeve, and a fourth cavity 24 may be a fourth hollow sleeve. In some examples, the first, second and fourth hollow sleeves may have a circular-shaped opening and the third hollow sleeve may have an oval-shaped opening.

Additionally, each one of the second eccentric pins 22 may be configured to rotate to adjust the respective position of the respective printhead 11 relative to the printbar beam member 10, for example, along a second axis 20b along the beam surface 10a. The second axis 20b may be different than the first axis 20a. In some examples, the second axis 20b may be in a printing direction and the first axis 20a may be traverse to the printing direction. In some examples, a rotation of the respective first and second eccentric pins 12 and 22 of the respective printhead 11 may be configured to move the respective printhead 11 along the printbar beam surface 10a relative to other printheads thereon.

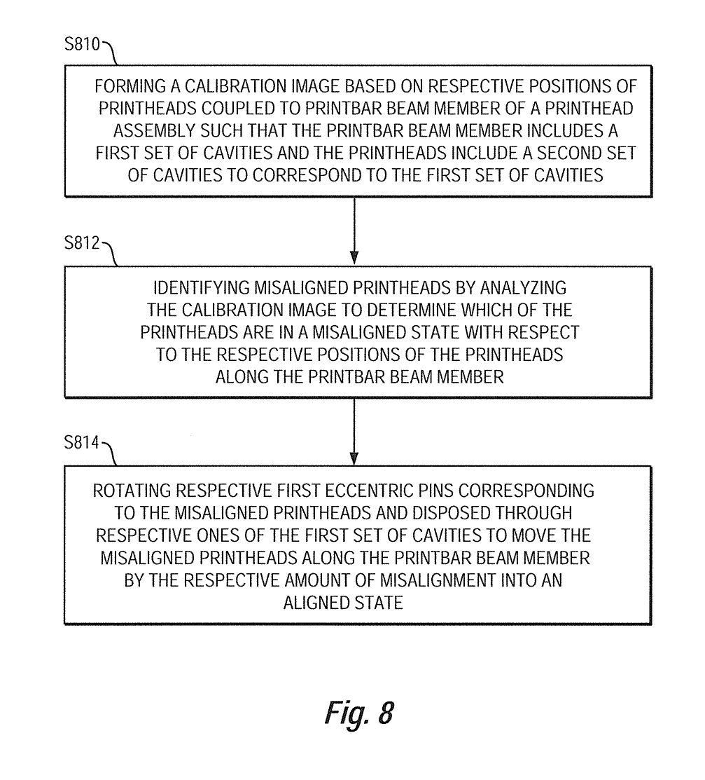

FIG. 7 is a flowchart illustrating a method of calibrating a printhead assembly according to an example. In some examples, the modules and/or assemblies implementing the method may be those described in relation to the printhead assemblies 100, 200 and 500 of FIGS. 1-6. In block S710, a calibration image is formed based on respective positions of printheads coupled to a printbar beam member of the printhead assembly such that the printbar beam member includes a first set of cavities and the printheads include a second set of cavities to correspond to the first set of cavities. In some examples, the first cavity may include a first hollow sleeve and the second cavity may include a second hollow sleeve. The calibration image may be printed onto a media by each one of the printheads. In block S712, the calibration image is analyzed to identify which of the printheads are in a misaligned state with respect to the respective positions of the printheads along the printbar beam member.

In block S714, the misaligned printheads are removed from the printbar beam member. In block S716, respective first eccentric pins corresponding to the misaligned printheads and disposed through respective ones of the second set of cavities are rotated to enable the misaligned printheads, for example, to be placed in an aligned state. In some examples, the method may also include engaging respective ones of the first set of cavities of the misaligned printheads by the respective first eccentric pins to place the misaligned printheads in the aligned state.

FIG. 8 is a flowchart illustrating a method of calibrating a printhead assembly according to an example. In some examples, the modules and/or assemblies implementing the method may be those described in relation to the printhead assemblies 100, 200 and 500 of FIGS. 1-6. In block S810, a calibration image is formed based on respective positions of printheads coupled to a printbar beam member of the printhead assembly such that the printbar beam member includes a first set of cavities and the printheads include a second set of cavities to correspond to the first set of cavities. In some examples, the first cavity may include a first hollow sleeve and the second cavity may include a second hollow sleeve. The calibration image may be printed onto a media by each one of the printheads. In block S812, misaligned printheads are identified by analyzing the calibration image to determine which of the printheads are in a misaligned state with respect to the respective positions of the printheads along the printbar beam member. In block S814, respective first eccentric pins corresponding to the misaligned printheads and disposed through respective ones of the first set of cavities are rotated to move the misaligned printheads along the printbar beam member by the respective amount of misalignment, for example, into an aligned state. In some examples, the method also includes determining an amount of misalignment (e.g., displacement distance) for each one of the misaligned printheads by performing an open loop calibration. Alternatively, in some examples, the method may include performing a closed loop calibration by physically measuring an amount of misalignment for each one of the misaligned printheads.

It is to be understood that the flowcharts of FIGS. 7 and 8 illustrate architecture, functionality, and/or operation of examples of the present disclosure. If embodied in software, each block may represent a module, segment, or portion of code that includes one or more executable instructions to implement the specified logical function(s). If embodied in hardware, each block may represent a circuit or a number of interconnected circuits to implement the specified logical function(s). Although the flowcharts of FIGS. 7 and 8 illustrate a specific order of execution, the order of execution may differ from that which is depicted. For example, the order of execution of two or more blocks may be rearranged relative to the order illustrated. Also, two or more blocks illustrated in succession in FIGS. 7 and 8 may be executed concurrently or with partial concurrence. All such variations are within the scope of the present disclosure.

The present disclosure has been described using non-limiting detailed descriptions of examples thereof that are not intended to limit the scope of the general inventive concept. It should be understood that features and/or operations described with respect to one example may be used with other examples and that not all examples have all of the features and/or operations illustrated in a particular figure or described with respect to one of the examples. Variations of examples described will occur to persons of the art. Furthermore, the terms “comprise,” “include,” “have” and their conjugates, shall mean, when used in the disclosure and/or claims, “including but not necessarily limited to.”

It is noted that some of the above described examples may include structure, acts or details of structures and acts that may not be essential to the general inventive concept and which are described for illustrative purposes. Structure and acts described herein are replaceable by equivalents, which perform the same function, even if the structure or acts are different, as known in the art. Therefore, the scope of the general inventive concept is limited only by the elements and limitations as used in the claims.

1. A printhead assembly, comprising:
a printbar beam member having a beam surface and a first cavity disposed through the beam surface;
a printhead having a printhead surface and a second cavity disposed through the printhead surface; and
a first eccentric pin to insert into the first cavity and the second cavity to couple the printhead to the printbar beam member, the first eccentric pin to rotate to adjust a position of the printhead relative to the printbar beam member along a first axis of the beam surface.

2. The printhead assembly of claim 1, wherein the printbar beam member further comprises:
a third cavity disposed through the beam surface.

3. The printhead assembly of claim 2, wherein the printhead further comprises:
a fourth cavity disposed through the printhead surface.

4. The printhead assembly of claim 2, wherein the first cavity includes a first hollow sleeve, the second cavity includes a second hollow sleeve, a third cavity includes a third hollow sleeve, and a fourth cavity includes a fourth hollow sleeve.

5. The printhead assembly of claim 3, further comprising:
a second eccentric pin to insert into the third cavity and the fourth cavity to couple the printhead to the printbar beam member, the second eccentric pin to rotate to adjust the position of the printhead relative to the printbar beam member along a second axis of the beam surface different than the first axis.

6. A printhead assembly, comprising:
a printbar beam member having a beam surface and a plurality of first cavities disposed through the beam surface;
a plurality of printheads, each one having a printhead surface and a second cavities disposed through the respective printhead surface; and
a plurality of first eccentric pins, each one to insert into the respective first cavity and the corresponding second cavity to couple the respective printhead to the printbar beam member; and
wherein each one the first eccentric pins is configured to rotate to adjust the respective position of the respect printhead relative to the printbar beam member along a first axis of the beam surface.

7. The printhead assembly of claim 6, wherein the printbar beam member further comprises:
a plurality of third cavities disposed through the beam surface.

8. The printhead assembly of claim 7, wherein each one of the printheads further comprises:
a fourth cavity disposed through the respective printhead surface.

9. The printhead assembly of claim 8, wherein the first cavity includes a first hollow sleeve, the second cavity includes a second hollow sleeve, a third cavity includes a third hollow sleeve, and a fourth cavity includes a fourth hollow sleeve.

10. The printhead assembly of claim 8, wherein the printhead assembly further comprises:
a plurality of second eccentric pins, each one to insert into the respective third cavity and the corresponding fourth cavity to couple the respective printhead to the printbar beam member; and
wherein each one of the second eccentric pins is configured to rotate to adjust the respective position of the respective printhead relative to the printbar beam member along a second axis of the beam surface different than the first axis.

11. The printhead assembly of claim 10, wherein:
a rotation of the respective first eccentric pin of the respective printhead is configured to move the respective printhead along the printbar beam surface relative to other printheads thereon; and
a rotation of the respective second eccentric pin of the respective printhead is configured to move the respective printhead along the printbar beam surface relative to other printheads thereon.

12. A method of calibrating a printhead assembly, the method comprising:
forming a calibration image based on respective positions of printheads coupled to a printbar beam member of the printhead assembly such that the printbar beam member includes a first set of cavities and the printheads include a second set of cavities to correspond to the first set of cavities;
identifying misaligned printheads by analyzing the calibration image to determine which of the printheads are in a misaligned state with respect to the respective positions of the printheads along the printbar beam member;
removing the misaligned printheads from the printbar beam member; and
rotating respective first eccentric pins corresponding to the misaligned printheads and disposed through respective ones of the second set of cavities to enable the misaligned printheads to be placed in an aligned state.

13. The method of claim 12, further comprising:
engaging respective ones of the first set of cavities of the misaligned printheads by the respective first eccentric pins to place the misaligned printheads in the aligned state.

14. (canceled)

15. The method of claim 13, further comprising:
determining an amount of misalignment for each one of the misaligned printheads by performing at least one of an open loop calibration and a closed loop calibration.

16. The method of claim 13, further comprising:
receiving the printheads on the printbar member after the rotating of the first eccentric pins.
